(19) United States
(12) Patent Application Publication
(10) Pub. No.: US 2005/0040966 A1
(43) Pub. Date: Feb. 24, 2005

(54) [AUTO-CONTROL DEVICE AND METHOD OF REMOTELY CONTROLLING ELECTRONIC APPLIANCES]

(75) Inventor: Yung-Hui Wang, TAIPEI (TW)

Correspondence Address: PATEN WIRELESS TECHNOLOGY INC., 2F-4, NO. 148, SEC. 4, CHUNG HSIAO EAST ROAD, TAIPEI, TW

(73) Assignee: PATENT WIRELESS TECHNOLOGY INC., TAIPEI (TW)

(21) Appl. No.: 10/710,196

(22) Filed: Jun. 25, 2004

(30) Foreign Application Priority Data
Aug. 20, 2003 (TW) 092122922

(51) Int. Cl. H04Q 1/00

(52) U.S. Cl. 340/825

(57) ABSTRACT

An auto-control device and a method for remotely controlling household or office electronic appliances are provided. A command is wirelessly sent to at least a repeater corresponding to an electronic appliance using a system remote controller. The repeater wirelessly transmits the command to a central controller. The command is judged by the central controller which of the electronic appliance the command is, the central controller transmits the command wirelessly to the repeater for controlling the electronic appliance according to the command.

### CROSS REFERENCE TO RELATED APPLICATIONS

This application claims the priority benefit of Taiwan patent application number 092122922 filed on Aug. 20, 2003.

### BACKGROUND OF INVENTION

1. The Field of the Invention

The present invention relates to an auto-control device and method of controlling electronic appliances, and more particularly to an auto-control device and method for remotely controlling electronic appliances in various rooms from anywhere.

2. Description of Related Art

The economy growth and advancement of various technologies, especially for computer, communication, network controlling technique and information technologies, have greatly modernized our everyday life, providing convenience and safer environment. Thus, the improved modern technologies have positively affected our every day life in every way to a higher quality life. The automation technology is applied in various fields, for example, for controlling household electronic appliances. The convenience provided by the automation makes it essential for managing our everyday life.

Nowadays, several electronic appliance manufacturers have invested in the development of household automation. According released data, the nationwide market for household electronic products is about 200 billion, and with the yearly growth of about 5% to 10%. The household automation technology primarily commenced with the wireless receiving and the transmitting devices, which allowed user to remotely control the household electronic appliances. However, it usual that there are a variety of electronic appliances in every homes and each electronic appliance has its own exclusive remote controller, and thus provides inconvenience to the user. In order to resolve this problem, some manufacturers proposed a single multi-functional remote controller to operate various electronic appliances by automatically scanning and locking the code to set the operation parameters of the electronic appliances and store therein. However, such the wireless control has the operation range limitation and therefore the user is unable to operate from a place beyond the range limit thus causing inconvenience.

For providing long distance remote control of household electronic appliances, some manufacturers proposed using a phone system to achieve the long distance control of household electronic appliances. Although the user uses the well-developed telephone network as the transmission channel, the user has to go through the long and unnecessary setting up procedure and also need a long time learning the procedure. This is not only waste of time but also the chances of making mistake in operating or setting up is high. Besides, the user is also limited by telephone to input interface and need to encode the electronic appliances and system commands and to memorize the codes thereof. Accordingly, the above-mentioned method is not practical. Therefore, to resolve the above defects is an important issue for the manufacturers in the field.

### SUMMARY OF INVENTION

Accordingly, in the view of the foregoing, the present inventor makes a detailed study of related art to evaluate and consider, and uses years of accumulated experience in this field, and through several experiments, to create a new auto-control device and method of remotely controlling electronic appliances. The present invention provides an innovated cost effective auto-control device and method for remotely controlling electronic appliances in any room from anywhere.

According to an aspect of the present invention, by installing a repeater and a central controller a system remote controller can control the electronic appliances in any room from anywhere.

According to another aspect of the present invention, the central controller can be linked to a computer via internet for remotely controlling all the electronic appliances.

According to another aspect of the present invention, the repeater can be used to transmit data covering a substantially larger range.

### BRIEF DESCRIPTION OF DRAWINGS

For a more complete understanding of the present invention, reference will now be made to the following detailed description of preferred embodiments taken in conjunction with the following accompanying drawings.

FIG. 1 is a view showing a host end of a remote control system according to an embodiment of the present invention.

FIG. 2 is a view showing an application of a first repeater end of a remote control system according to an embodiment of the present invention.

FIG. 3 is a view showing an application of a second repeater end of a remote control system according to an embodiment of the present invention.

FIG. 4 is a view showing an application of a third repeater end of a remote control system according to an embodiment of the present invention.

FIG. 5 is a view showing an application of a fourth repeater end of a remote control system according to an embodiment of the present invention.

FIG. 6 is a view showing an application of a fifth repeater end of a remote control system according to an embodiment of the present invention.

FIG. 7 is a flowchart illustrating an operation procedure for controlling the electronic appliance using the remote system controller according to an embodiment of the present invention.

FIG. 8 is a flowchart illustrating an operation procedure for controlling the electronic appliance using the remote system controller according to another embodiment of the present invention.

### DETAILED DESCRIPTION

Reference will be made in detail to the preferred embodiments of the invention, examples of which are illustrated in the accompanying drawings. Wherever possible, the same reference numbers are used in the drawings and the description to refer to the same or like parts.

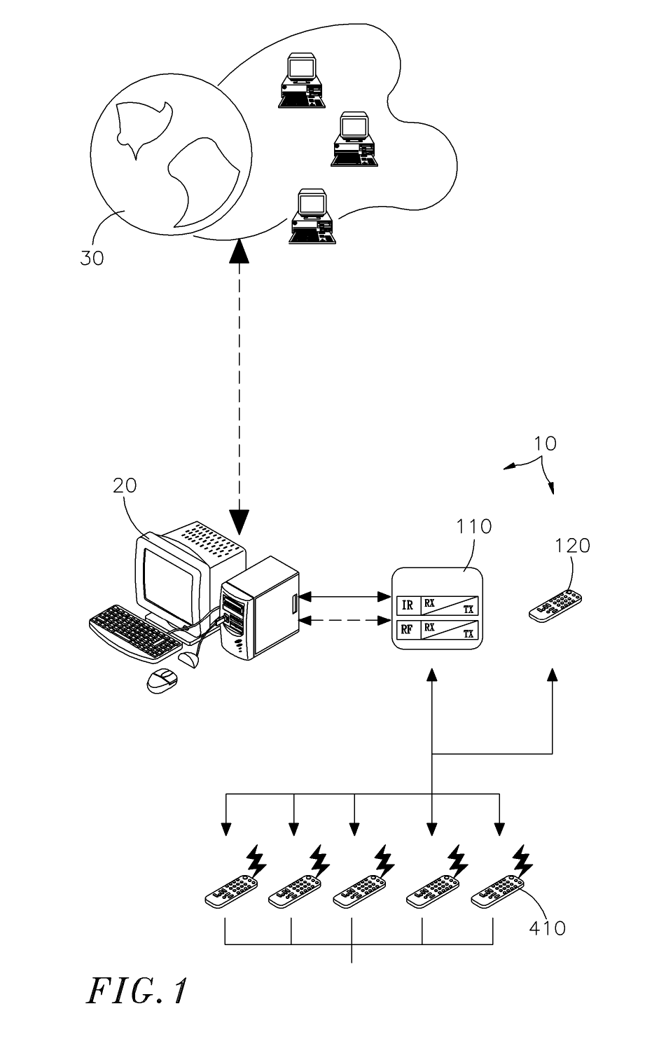

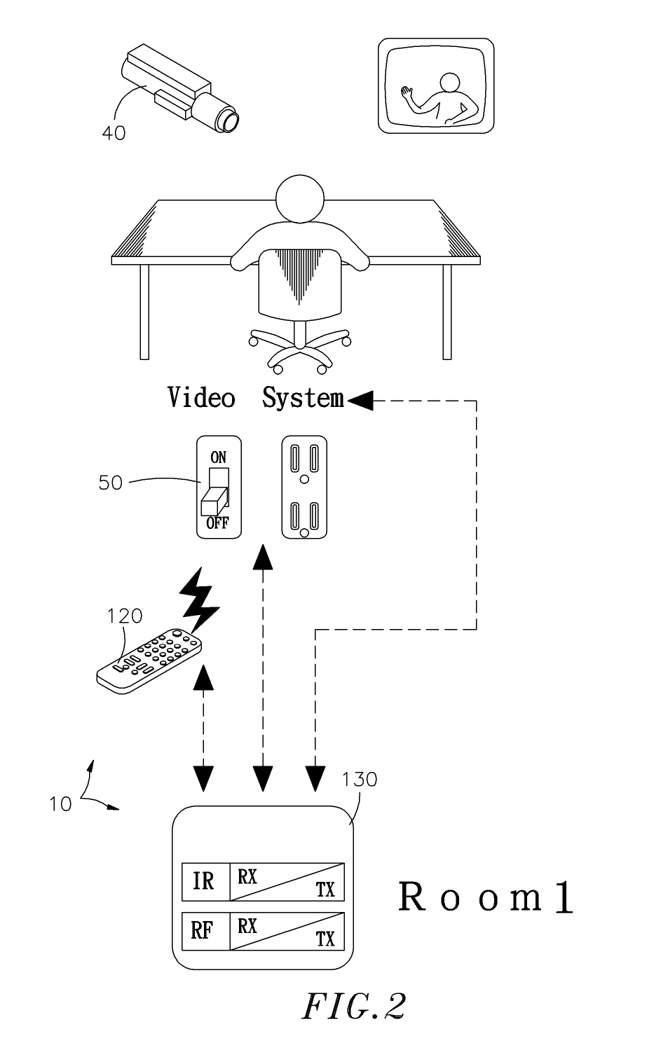

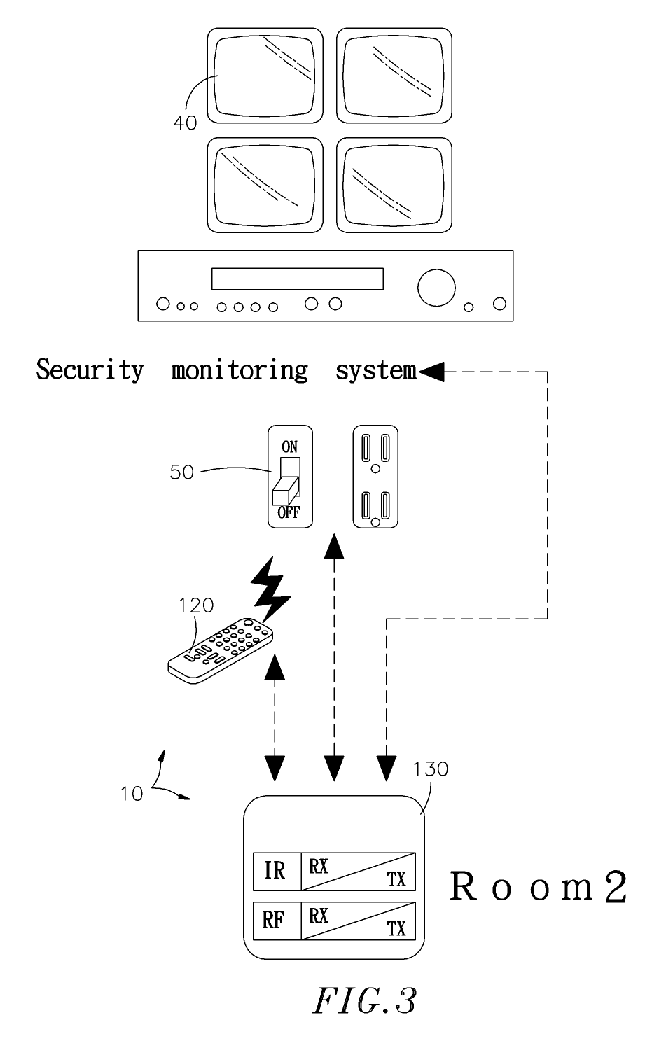

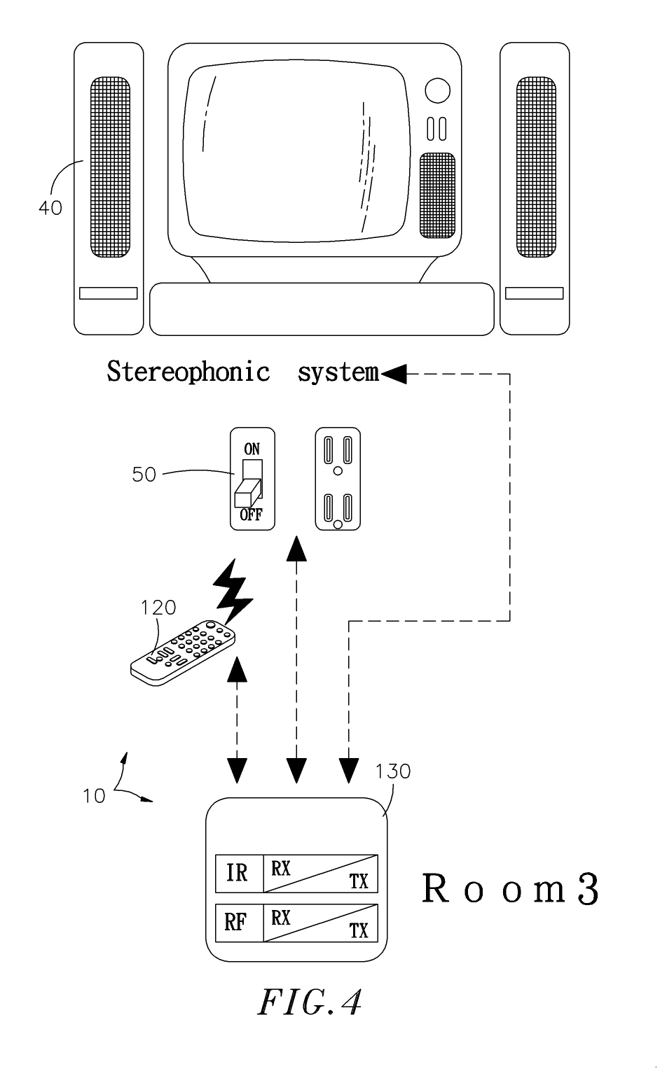

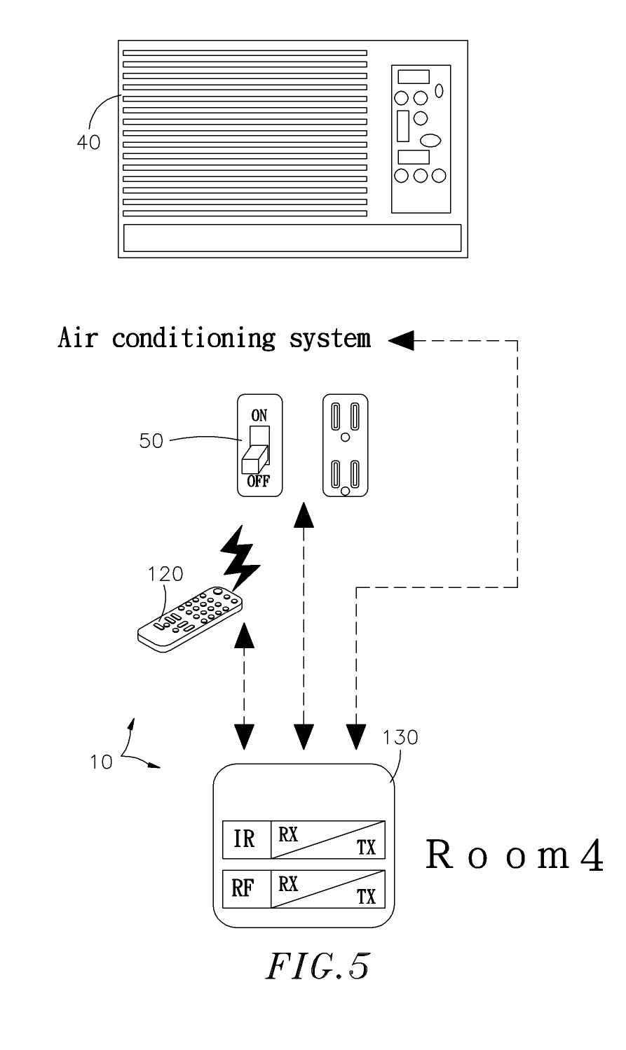

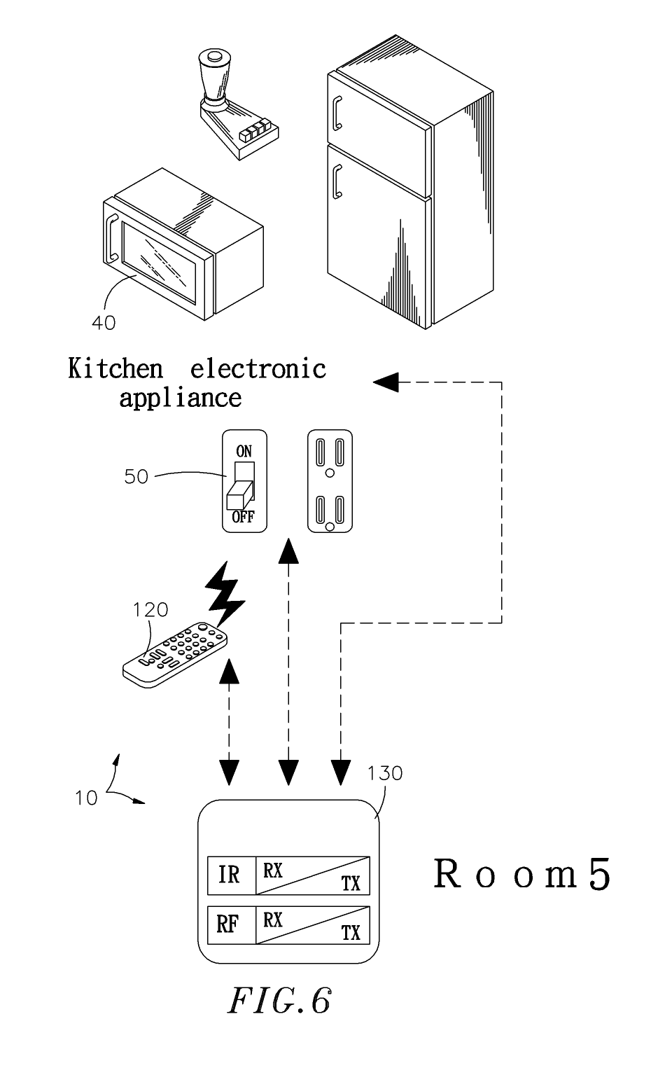

Referring to FIGS. 1, 2, 3, 4, 5 and 6, a host end of a remote control system, and views of a first, a second, a third, a fourth and a fifth repeater end of a remote control system, according to an embodiment of the present invention are shown respectively. The auto control device 10 comprises a central controller 110, a system remote controller 120 and a plurality of repeaters 130. The repeaters 130 are installed in various rooms. The central controller 110 is adapted for linking to a computer 20 capable of connecting to internet 30. The rooms having the repeater 130 include at least an electronic appliance 40 supplied with power via the power controller 50. The central controller 110 is capable of recording the operation manner of the remote controller 410 of the electronic appliance 40 by automatically scanning and locking the code and setting up the repeater 130 for allowing controlling of the electronic appliance 40. The system remote controller 120 can set up the operation parameters of the electronic appliance 40 recorded by the central controller 110.

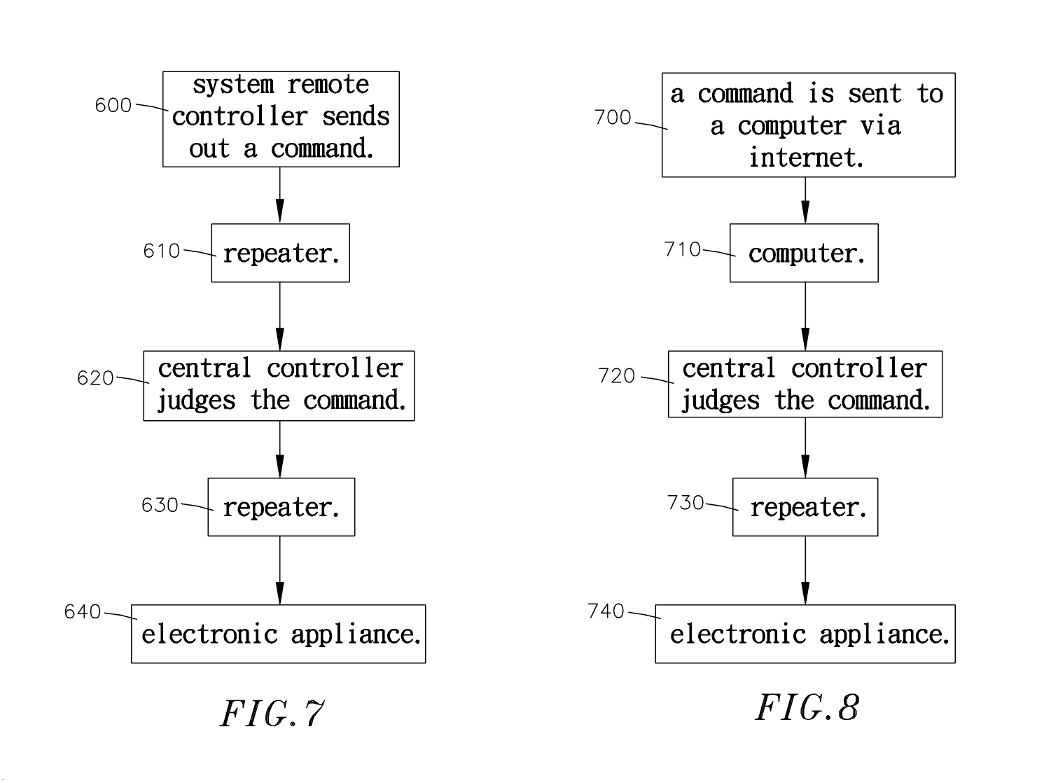

Referring to FIGS. 1, 2, 3, 4, 5, 6 and 7, a host end of a remote control system, and views of the first, the second, a third, the fourth and the fifth repeater end of the remote control system, and a flowchart illustrating an operation procedure for controlling the electronic appliance using the system remote controller according to an embodiment of the present invention are shown respectively. Hereinafter the operation procedure of the system remote controller 120 for controlling the electronic appliance 40 is described as follows.

At step 600, the button of the system remote controller 120 is activated, the system remote controller 120 sends out a command to the repeater 130.

At step 610, the repeater 130 receives the command from the system remote controller 120 and then transmits the command wirelessly to the central controller 110.

At step 620, the central controller 110 receives the command from the repeater 130 and judges to which of the electronic appliances 40 the command correspond to, then transmits the command wirelessly to the repeater 130 corresponding to the target electronic appliance 40.

At step 630, the repeater 130 receives the command from the central controller 110 and then transmits the command wirelessly to the target electronic appliance 40 to control the target electronic appliance 40 according to the command.

At step 640, the electronic appliance 40 is controlled according to the command.

Referring to FIGS. 1, 2, 3, 4, 5, 6 and 8, a host end of a remote control system, and views of the first, the second, a third, the fourth and the fifth repeater end of the remote control system, and a flowchart illustrating an operation procedure for controlling the electronic appliance using the system remote controller according to another embodiment of the present invention are shown respectively.

According to this embodiment, the electronic appliance 40 is controlled via internet 30. The operation procedure of this embodiment of the present invention is described as follows.

At step 700, a command is sent to a computer 20 via internet 30.

At step 710, the computer 20 receives the command via internet 30 and then transmits the command wirelessly or via wire to the central controller 110.

At step 720, the central controller 110 receives the command from the computer 20 and judges to which electronic appliances 40 the command correspond to and then transmits the command wirelessly to the repeater 130 corresponding to the target electronic appliance 40.

At step 730, the repeater 130 receives the command from the central controller 110 and then transmits the command wirelessly to the target electronic appliance 40 to control the target electronic appliance 40 according to the command.

At step 740, the electronic appliance 40 is controlled according to the command.

The auto control method of the present invention has the following advantages.

1. The system remote controller 120 can control the electronic appliances 40 in any rooms from anywhere the repeater 130 and the central controller 110.

2. The central controller 110 can be linked to the computer 20 via internet 30 for remotely controlling the electronic appliances 40 in various rooms of a users home.

3. All of the repeaters 130 can be used to transmit data to effectively enlarge the controlling range.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and nonlimiting sense.

1. An auto-control device, for remotely controlling household or office electronic appliances, comprising at least:
a plurality of repeaters, corresponding to each of said electronic appliances installed in various rooms, for controlling corresponding electronic appliances installed in various rooms;
a central controller, for recording various operation parameters of a remote controller of said various electronic appliances and said repeaters; and
a system remote controller, for setting operation frequencies of said electronic appliances stored in said central controller and transmitting a command to said repeaters wirelessly so that said remote controller can control said electronic appliances in various rooms from any room.

2. The auto-control device according to claim 1, wherein said central controller can be connected to a computer to link to internet for allowing users to remotely control said electronic appliances via internet.

3. A method of remotely controlling household or office electronic appliances, comprising:
(a) wirelessly sending a command to at least a repeater corresponding to an electronic appliance by activating a system remote controller;
(b) wirelessly transmitting said command received from said repeater to a central controller;
(c) judging said command which of said electronic appliances to control and transmitting said command wirelessly to repeater corresponding to said electronic appliance, wherein the judging step is carried out by said central controller and the transmitting said command wirelessly is carried out by the central controller;
(d) wirelessly transmitting said command from said repeater to said electronic appliance; and
(e) controlling said electronic appliance according to the command.

4. A method of remotely controlling household or office electronic appliances, the method comprising:
(a) sending a command to a computer via internet;
(b) transmitting said command received by said computer to a central controller;
(c) judging said command to which of said electronic appliance to control transmitting said command wirelessly to a repeater corresponding to said electronic appliance, wherein the judging step is carried out by said central controller and the transmitting said command wirelessly is carried out by the central controller;
(d) wirelessly transmitting said command from said repeater to said electronic appliance; and
(e) controlling said electronic appliance according to the command.
